(19) United States
(12) Patent Application Publication
(10) Pub. No.: US 2017/0115170 A1
(43) Pub. Date: Apr. 27, 2017

(54) SENSING DEVICE AND METHOD FOR SENSING A FORCE

(71) Applicant: Agency for Science, Technology and Research, Singapore (SG)

(72) Inventors: Zhihao CHEN, Singapore (SG); Ju Teng TEO, Singapore (SG); Soon Huat NG, Singapore (SG); Xiufeng YANG, Singapore (SG)

(73) Assignee: Agency for Science, Technology and Research, Singapore (SG)

(21) Appl. No.: 15/129,277

(22) PCT Filed: Mar. 25, 2015
(86) PCT No.: PCT/SG2015/000091

§ 371 Date: Sep. 26, 2016

(30) Foreign Application Priority Data
Mar. 26, 2014 (SG) 10201400990Q

(51) Int. Cl. G01L 1/24

(52) U.S. Cl. CPC G01L 1/243

(57) ABSTRACT

According to embodiments of the present invention, a sensing device is provided. The sensing device includes a sensor arrangement including an optical fiber, and at least one spacer element arranged adjacent to the optical fiber, wherein the optical fiber and the at least one spacer element are adapted to cooperate to receive a force applied to the sensor arrangement to modulate an optical signal propagating in the optical fiber. According to further embodiments of the present invention, a method for sensing a force is also provided.

### CROSS-REFERENCE TO RELATED APPLICATION

This application claims the benefit of priority of Singapore patent application No. 10201400990Q, filed 26 Mar. 2014, the content of it being hereby incorporated by reference in its entirety for all purposes.

### TECHNICAL FIELD

Various embodiments relate to a sensing device and a method for sensing a force.

### BACKGROUND

Force sensors are widely used in many applications such as medical, health care and industrial areas. Optical fiber pressure sensors have attracted much attention recently because of its electromagnetic immunity, intrinsically safe modes of operation and light weight. However, the dynamic working range is not enough when a pressure of force applied to the sensors exceeds a certain value.

There is therefore need to provide a sensing device with increased or larger dynamic working range.

### SUMMARY

According to an embodiment, a sensing device is provided. The sensing device may include a sensor arrangement including an optical fiber, and at least one spacer element arranged adjacent to the optical fiber, wherein the optical fiber and the at least one spacer element are adapted to cooperate to receive a force applied to the sensor arrangement to modulate an optical signal propagating in the optical fiber.

According to an embodiment, a method for sensing a force is provided. The method may include providing an optical signal to an optical fiber for propagation in the optical fiber, applying a force to the optical fiber and at least one spacer element arranged adjacent to the optical fiber to modulate the optical signal propagating in the optical fiber, and detecting the optical signal modulated by the force.

### BRIEF DESCRIPTION OF THE DRAWINGS

In the drawings, like reference characters generally refer to like parts throughout the different views. The drawings are not necessarily to scale, emphasis instead generally being placed upon illustrating the principles of the invention. In the following description, various embodiments of the invention are described with reference to the following drawings, in which:

FIG. 1 shows a schematic diagram of a sensing device.

FIG. 2A shows a plot of sensor output of the sensing device of FIG. 1 as a function of weight, while FIG. 2B shows a plot of the sensitivity of the sensor mat of the sensing device of FIG. 1.

FIG. 3 shows a plot of sensor output of a sensing device having a sensor mat with and without a spacer.

FIG. 4A shows a schematic perspective view of a sensing device, according to various embodiments.

FIG. 4B shows a flow chart illustrating a method for sensing a force, according to various embodiments.

FIG. 5A shows a schematic perspective view of a sensing device, according to various embodiments.

FIG. 5B shows a schematic top view of a sensor arrangement of the sensing device of FIG. 5A.

FIG. 5C shows a schematic perspective view of a sensor arrangement of the sensing device of FIG. 5A.

FIG. 6 shows an image of a section of the mesh-like structure of at least one of the top or bottom layers of the sensor mat of various embodiments.

FIG. 7 shows a plot of results illustrating the relationship between optical loss and weight for the sensing device of various embodiments.

FIGS. 8A and 8B show measurement results for seating applications using the sensor mat of various embodiments.

FIGS. 9A and 9B show measurement results for standing applications using the sensor mat of various embodiments.

FIG. 10 shows a diagram illustrating a method used for body weight measurement, according to various embodiments.

FIG. 11 shows a typical ballistocardiogram (BCG) waveform measured using the sensor mat of various embodiments.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Embodiments described in the context of one of the methods or devices are analogously valid for the other methods or devices. Similarly, embodiments described in the context of a method are analogously valid for a device, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the phrase “at least substantially” may include “exactly” and a reasonable variance.

In the context of various embodiments, the term “about” or “approximately” as applied to a numeric value encompasses the exact value and a reasonable variance.

As used herein, the term “and/or” includes any and all combinations of one or more of the associated listed items.

As used herein, the phrase of the form of “at least one of A or B” may include A or B or both A and B. Correspondingly, the phrase of the form of “at least one of A or B or C”, or including further listed items, may include any and all combinations of one or more of the associated listed items.

Various embodiments may provide a vital signs monitoring device (or sensing device) with adjustable or increased dynamic working range.

Various embodiments may provide a method and a medical device (or sensing device) made of or including a fiber optic sensor mat (or fiber optic sensor arrangement) and a transceiver for measurements of at least one of breathing rate, heart rate, body force or body movement. The body force to be measured may include body weight and/or heart force, e.g., cardiac force, etc. The sensor mat may be configured in a manner that the top and bottom layers of the sensor mat may contain polyester fiber with large area mesh-like structures, and in between the top and bottom layers, may be a section of a multimode fiber and one or more dummy fiber(s) (e.g., as spacer(s)) or plastic/metal tube/rod as spacers to adjust (e.g., increase) the sensor mat's dynamic working range. The transceiver may consist of or include a light source, a detector, and a signal processing unit with display and alarm functions to report results and alert the user(s) of the device.

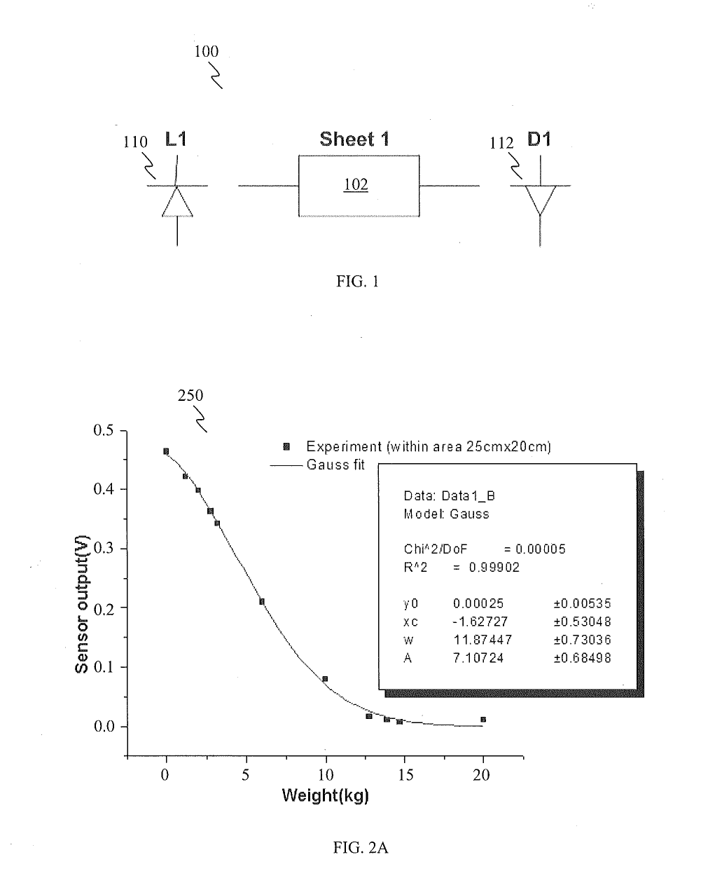

FIG. 1 shows a schematic diagram of a sensing device 100, illustrating the various components or elements of the sensing device 100. The sensing device (or sensor) 100 may include a sensor mat (indicated as Sheet 1) 102, which may be a microbending-based fiber optic sensor mat without any spacer, a light source (L1) 110 and a detector (D1) 112. The sensor mat 102 may include a top layer and a bottom layer, and may be configured in a manner that each of the top and bottom layers may contain one or more polyester fibers with a large area mesh-like structure, where in between the top and bottom layers is a section of a multimode fiber. While the sensor mat 102, the light source 110 and the detector 112 of the sensing device 100 are shown separate from each other, it should be appreciated that the sensor mat 102, the light source 110 and the detector 112 may be coupled to each other, including, for example, mechanically coupled and/or optically coupled to one another.

The sensing device 100 may be used as a test set-up for various measurements, where a force or a weight to be measured may be applied to the sensor mat 102. As a non-limiting example, the sensor mat 102 may have a contact area, for weight, of approximately 25 cm×30 cm, where the area of 0.05 m² is chosen for the purpose of sensor characterization.

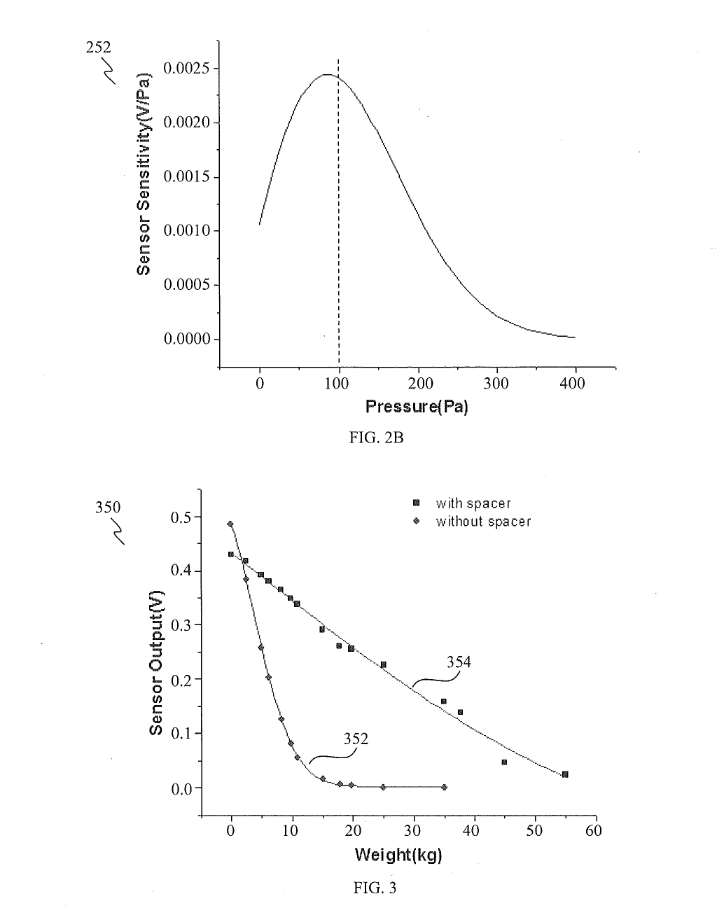

FIG. 2A shows a plot 250 of sensor output of the sensing device 100 as a function of weight, illustrating a typical curve of the sensor output as a function of weight. As may be observed, there is a substantially perfect Gauss fit. FIG. 2B shows a plot 252 of the sensitivity of the sensor mat 102 of the sensing device 100, illustrating a typical curve of the sensor mat's sensitivity.

As shown in FIG. 2A, the relationship between the sensor output, in the form of voltage amplitude, for example as obtained using the detector 112, and the weight is not linear. From FIG. 2B, it may be observed that the sensor mat 102, and the sensing device 100, has a higher sensitivity around 100 Pa. The sensitivity is low after about 300 Pa. This means that the sensor mat 112 may have less sensitivity to a large body weight compared to a small body weight. In addition, the dynamic working range is less than about 13 kg for the sensing device 100.

In order to address the above-mentioned problems, various embodiments may provide a method and a device where one or more dummy plastic rods/tubes or fibers may be used as spacer(s) or spacer element(s) to increase the sensor mat's dynamic working range, as illustrated in FIG. 3.

FIG. 3 shows a plot 350 of sensor output of a sensing device having a sensor mat with and without a spacer, within a sensor mat area of approximately 0.05 m². In various embodiments where the sensor mat includes a spacer, the spacer may have a diameter of about 0.9 mm, with a total length of about 450 cm. The plot 350 shows results 352 for a sensor mat without any spacer and results 354 for a sensor mat with a spacer. It may be seen from FIG. 3 that with a spacer, the sensor mat, and also the sensing device's dynamic range of operation may be extended beyond about 50 kg, while for a sensor mat without a spacer, the sensor may not work beyond approximately 15 kg.

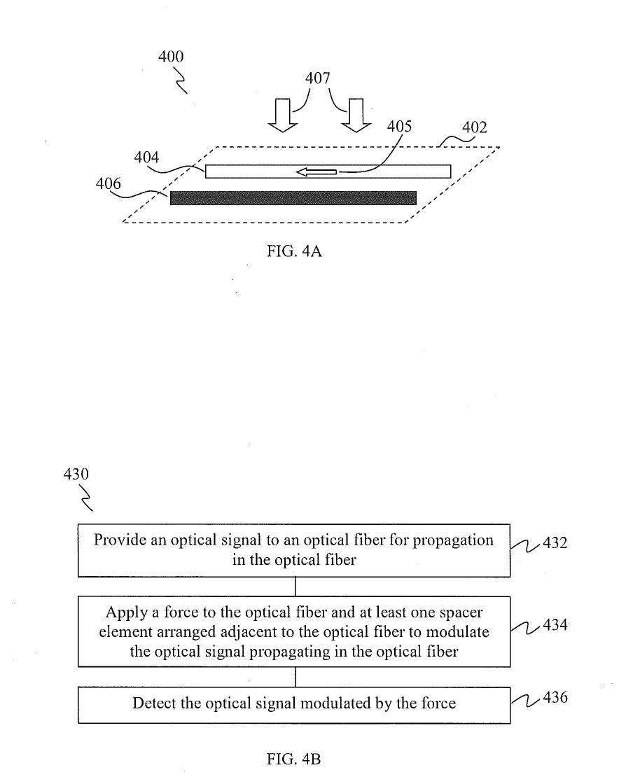

FIG. 4A shows a schematic perspective view of a sensing device 400, according to various embodiments. The sensing device 400 includes a sensor arrangement (as represented by the dashed box 402) including an optical fiber 404, and at least one spacer element 406 arranged adjacent to the optical fiber 404, wherein the optical fiber 404 and the at least one spacer element 406 are adapted to cooperate to receive a force (as represented by the arrows 407) applied to (or exerted on) the sensor arrangement 402 to modulate an optical signal (e.g., light) (as represented by the arrow 405) propagating in the optical fiber 404.

In other words, the sensing device 400 may include a sensor arrangement 402 having an optical fiber 404 and at least one spacer element 406 arranged next to the optical fiber 404. The optical fiber 404 and the at least one spacer element 406 may be arranged in a side-by-side configuration, defining an effective area or surface to receive the force 407 applied to the sensor arrangement 402. In this way, the optical fiber 404 and the at least one spacer element 406 may support the force 407 together such that the force 407 applied to the sensor arrangement 402 may be distributed between the optical fiber 404 and the at least one spacer element 406, and thus the total or effective force exerted on the optical fiber 404 itself may be reduced.

In various embodiments, as part of the force 407 applied to the sensor arrangement 402 may be transferred to the at least one spacer element 406, the effective force exerted on the optical fiber 404 may be reduced and thus the dynamic range of the sensor arrangement 402, and therefore also the dynamic range of the sensing device 400, may be increased. In this way, the at least one spacer element 406 may assist in increasing the dynamic working range of the sensor arrangement 402, and also of the sensing device 400.

In the context of various embodiments, the force 407 applied to the sensor arrangement 402 may, for example, be a force exerted by a user or person, such as a force or pressure exerted by a human body on the sensor arrangement 402, for example, due to breathing and/or heart beating.

In the context of various embodiments, the optical fiber 404 may include at least one of a glass optical fiber, or a plastic optical fiber. Other types of optical fibers may also be used.

In the context of various embodiments, the optical fiber 404 may have a length, in a range of between about 0.05 meter and about 30 meters, for example, between about 0.05 m and about 20 m, between about 0.05 m and about 10 m, between about 0.05 m and about 5 m, between about 1 m and about 30 m, between about 1 m and about 10 m, or between about 5 m and about 20 m.

In the context of various embodiments, the optical fiber 404 may have a radius in a range of between about 125 micrometers and about 1200 micrometers, for example, between about 125 μm and about 1000 μm, between about 125 μm and about 500 μm, between about 125 μm and about 300 μm, between about 200 μm and about 1200 μm, between about 500 μm and about 1200 μm, or between about 200 μm and about 500 μm.

In the context of various embodiments, a radius of a core of the optical fiber 404 may be in a range of between about 4 micrometers and about 1000 micrometers, for example, between about 4 μm and about 500 μm, between about 4 μm and about 200 μm, between about 50 μm and about 1000 μm, between about 100 μm and about 1000 μm, between about 500 μm and about 1000 μm, or between about 200 μm and about 500 μm.

In the context of various embodiments, the at least one spacer element 406 or each spacer element 406 may have a cross-sectional dimension (e.g., diameter) in a range of between about 125 micrometers and about 3000 micrometers, for example, between about 125 μm and about 2000 μm, between about 125 μm and about 1000 μm, between about 125 μm and about 500 μm, between about 500 μm and about 2000 μm, between about 1000 μm and about 2000 μm, or between about 500 μm and about 1000 μm.

In the context of various embodiments, the at least one spacer element 406 or each spacer element 406 may have a length in a range of between 0.05 meters and about 30 meters, for example, between about 0.05 m and about 20 m, between about 0.05 m and about 10 m, between about 0.05 m and about 5 m, between about 1 m and about 30 m, between about 1 m and about 10 m, or between about 5 m and about 20 m.

In the context of various embodiments, the sensor arrangement 402 may be a force sensor. In the context of various embodiments, the sensing device 400 may be a force sensing device.

In various embodiments, the optical fiber 404 and the at least one spacer element 406 may be arranged spaced apart from each other. In other words, a gap or a spacing may be provided between the optical fiber 404 and the at least one spacer element 406.

In various embodiments, the optical fiber 404 and the at least one spacer element 406 may be arranged in a same plane. This may mean that the optical fiber 404 and the at least one spacer element 406 may be arranged coaxially, within the plane. In this way, the optical fiber 404 and the at least one spacer element 406 may define an effective area or surface to receive the force 407 applied to the sensor arrangement 402.

In various embodiments, the optical fiber 404 may be arranged in a serpentine (or meander) shape, and having at least two sections facing each other. The at least two sections of the optical fiber 404 may be adjacent or neighbouring sections.

In various embodiments, the at least two sections of the optical fiber 404 may be arranged at least substantially parallel to each other.

In various embodiments, the at least two sections of the optical fiber 404 may be arranged spaced apart from each other.

In various embodiments, the at least one spacer element 406 may be arranged in between the at least two sections of the optical fiber 404.

In various embodiments, the at least one spacer element 406 may be arranged adjacent to at least one of the at least two sections of the optical fiber 404. The at least one spacer element 406 may be arranged at least substantially parallel to at least one of the at least two sections of the optical fiber 404.

In various embodiments, the optical fiber 404 may be arranged with at least one curved (or bent) section. In various embodiments, sections of the optical fiber 404 adjacent to (e.g., before and after) the at least one curved section may face each other (e.g., arranged parallel to each other).

In various embodiments, the optical fiber 404 may be arranged with a plurality of curved (or bent) sections. In various embodiments, a pitch or period, p, between adjacent curved sections of the plurality of curved sections may be in a range of between about 2 centimeters and about 10 centimeters, for example, between about 2 cm and about 5 cm, between about 5 cm and about 10 cm, or between about 3 cm and about 8 cm.

In various embodiments, the optical fiber 404 may include a multimode optical fiber.

In various embodiments, the at least one spacer element 406 may include at least one of a dummy optical fiber, a tube or a rod. In various embodiments, the tube or rod may be plastic or metal.

In various embodiments, a dummy optical fiber may mean an optical fiber with no optical signal propagating through the dummy optical fiber. This may mean that the optical signal 405 propagating though the optical fiber 404 of the sensor arrangement 402 does not propagate through the dummy optical fiber defining the spacer element. In various embodiments, the dummy optical fiber may include a glass optical fiber or a plastic optical fiber.

In various embodiments, the sensor arrangement 402 may include a plurality of spacer elements arranged adjacent to the optical fiber 404. As non-limiting examples, a respective spacer element of the plurality of spacer elements may be arranged adjacent to a respective section or partial section of the optical fiber 404, or arranged in between adjacent sections (which may be facing each other) of the optical fiber 404.

In various embodiments, the sensor arrangement 402 may further include a pair of cover layers, and wherein the optical fiber 404 and the at least one spacer element 406 may be arranged in between the pair of cover layers. The pair of cover layers may define a top (cover) layer and a bottom (cover) layer. In various embodiments, the sensor arrangement 402 may be configured as a sensor mat (e.g., a fiber optic sensor mat) having the pair of cover layers, the optical fiber 404 and the at least one spacer element 406.

In various embodiments, each cover layer of the pair of cover layers may include a plurality of fibrous materials arranged in a mesh-like structure. The plurality of fibrous materials may include a polymer, meaning polymer fibrous materials, or a metal and/or a plastic material. The fibrous materials may include but not limited to, polyester fibers.

In the context of various embodiments, a pitch or period between adjacent fibrous materials of the plurality of fibrous materials may be in a range of a few hundred microns (μm) to a few millimeters (mm), for example, between about 100 μm and about 10 mm (10000 μm), for example, between about 100 μm and about 5 mm, between about 100 μm and about 1 mm, between about 1 mm and about 10 mm, between about 1 mm and about 5 mm, or between about 200 μm and about 500 μm.

In various embodiments, a gap may be defined between adjacent fibrous materials of the plurality of fibrous materials arranged in the mesh-like structure. The gap may have a shape of a square, a rectangle or any other suitable shapes.

In various embodiments, the sensing device 400 may further include an optical transceiver optically coupled to the optical fiber 404 of the sensor arrangement 402.

In various embodiments, the optical transceiver may include an optical source (e.g., a light source) configured to generate the optical signal 405 propagating in the optical fiber 404. The optical source may be optically coupled to one end of the optical fiber 404. The optical source may be optically coupled to the one end of the optical fiber 404 via an additional optical fiber. The additional optical fiber may be coupled to the one end of the optical fiber 404 via splicing or via a fiber connector. The additional optical fiber may be a multimode fiber or a single mode fiber. In various embodiments, the optical source may be a light emitting device or diode (LED), a laser, or any type of broad band or narrow band light source.

In various embodiments, the optical transceiver may include an optical detector (e.g., a light detector) configured to detect the optical signal 405 that is modulated by force 407 applied to the sensor arrangement 402. The optical detector may receive and convert the modulated optical signal into an electrical signal. The optical detector may be optically coupled to another (opposite) end of the optical fiber 404. The optical detector may be optically coupled to the other end of the optical fiber 404 via a further additional optical fiber. The further additional optical fiber may be coupled to the other end of the optical fiber 404 via splicing or via a fiber connector. The further additional optical fiber may be a multimode fiber or a single mode fiber. In various embodiments, the optical detector may be a photodetector or a photodiode.

In various embodiments, the sensing device 400 may further include a processing circuit (e.g., a signal processing unit) configured to retrieve information corresponding to the force 407 from the optical signal 405 that is modulated by the force 407 applied to the sensor arrangement 402. In various embodiments, the processing circuit may be part of the optical transceiver.

In the context of various embodiments, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a ‘circuit’ in accordance with an alternative embodiment.

In various embodiments, the information retrieved may be related to at least one of breathing rate, heart beat rate, body force or body movement of a user applying the force 407 to the sensor arrangement 402.

In various embodiments, the processing circuit may be electrically coupled to the optical transceiver, e.g., electrically coupled to the optical detector.

In various embodiments, the processing circuit may include a display for displaying results of the sensing or measurement.

In various embodiments, the processing circuit may include an alarm module for alerting a user, e.g., the alarm module may include a visual unit for outputting an image and/or an audio unit for outputting a sound.

In the context of various embodiments, the sensing device 400 may be a monitoring device or a medical device for measurement of at least one of breathing rate, heart rate, body force or body movement of a user.

FIG. 4B shows a flow chart 430 illustrating a method for sensing a force, according to various embodiments.

At 432, an optical signal is provided to an optical fiber for propagation in the optical fiber.

At 434, a force is applied to the optical fiber and at least one spacer element arranged adjacent to the optical fiber to modulate the optical signal propagating in the optical fiber.

At 436, the optical signal modulated by the force is detected.

In various embodiments of the method, information corresponding to the force may be retrieved from the detected optical signal. The information may be related to at least one of breathing rate, heart beat rate, body force or body movement of a user or person.

Various embodiments may provide a sensor arrangement, for example, in the form of a sensor mat. The sensor arrangement may include a top layer and a bottom layer, which may act as first and second cover layers. Each of the top and bottom layers may include fibers or fibrous materials (e.g., polyester fibers) arranged in a mesh-like structure, with gaps or holes in between adjacent fibers. The sensor arrangement may be configured in a manner that the top and bottom layers contain the fibers (e.g., polyester fibers) with large area mesh-like structures, and in between the top and bottom layers is a section or area containing an optical fiber (e.g., a multimode fiber) or a section of an optical fiber (e.g., a multimode fiber), and one or more spacers such as one or more dummy fibers (e.g., dummy optical fiber) and/or one or more tubes or rods (e.g., plastic and/or metal tubes or plastic and/or metal rods) so as to adjust the dynamic working range of the sensor arrangement (sensor mat) of various embodiments, and therefore also the dynamic working range of the sensing device of various embodiments.

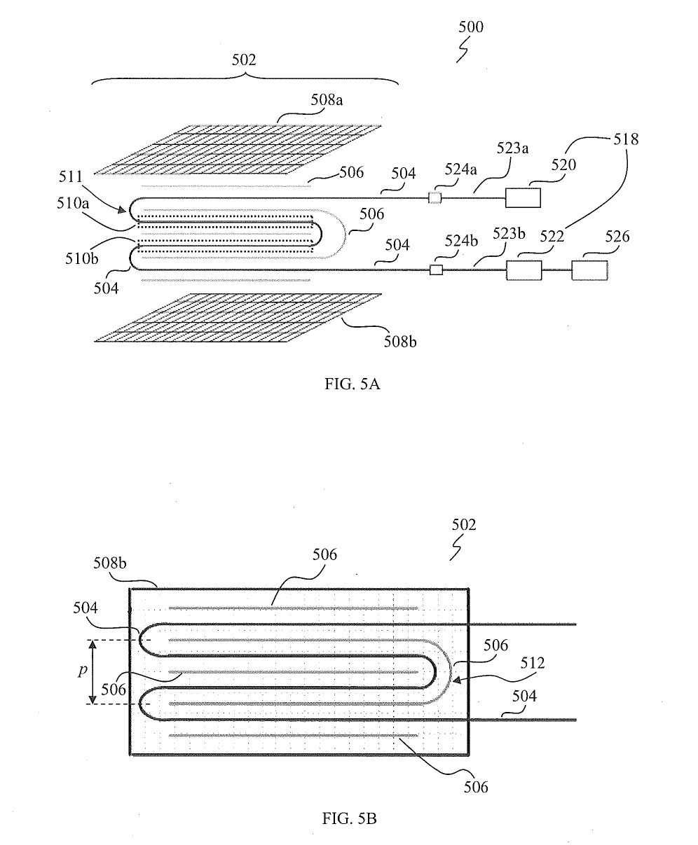

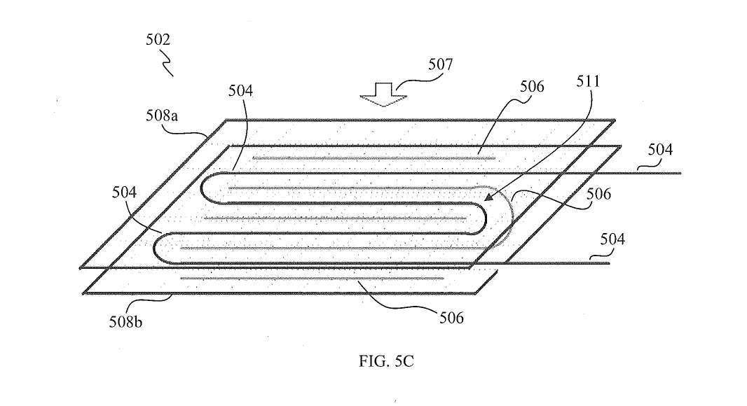

FIG. 5A shows a schematic perspective view of a sensing device 500, according to various embodiments, where a sensor arrangement 502 of the sensing device 500 is shown in an exploded view. FIGS. 5B and 5C shows schematic top and perspective views, respectively, of the sensor arrangement 502 of the sensing device 500.

Referring to FIGS. 5A to 5C showing the sensor arrangement 502 and the sensing device (or sensor) configuration, the sensing device 500 may include a sensor arrangement 502 having a top (cover) layer 508a and a bottom (cover) layer 508b, both layers 508a, 508b having polyester fibers (or polyester fibrous materials) with large area mesh-like structures. This may mean that each of the top layer 508a and the bottom layer 508b may include a mesh-like polyester fiber structure.

A section of a multimode fiber 504 or a section containing a multimode fiber 504 is arranged in between the layers 508a, 508b. The sensor arrangement 502 further includes at least one spacer or spacer element 506 arranged adjacent to the multimode fiber 504 or adjacent to a section of the multimode fiber 504, and in between the layers 508a, 508b. The spacer element 506 may be arranged spaced apart from the multimode fiber 504. The spacer element 506 may be arranged in the same plane as that of the multimode fiber 504. As a non-limiting example, as illustrated in FIGS. 5A to 5C, four spacer elements 506 may be provided. Each spacer element 506 may be a dummy fiber or dummy optical fiber, or a plastic/metal tube/rod.

The multimode fiber 504 may be arranged in a serpentine (or meander) shape. The multimode fiber 504 may have at least two sections (e.g., two such sections being shown within the dotted boxes 510a, 510b) facing each other. The two sections 510a, 510b may be neighbouring sections of the multimode fiber 504. The two sections 510a, 510b of the multimode fiber 504 may be arranged spaced apart from each other. The two sections 510a, 510b of the multimode fiber 504 may be arranged at least substantially parallel to each other. As shown in FIGS. 5A to 5C, as a non-limiting example, a spacer element 506 may be arranged in between the two (neighbouring) sections 510a, 510b.

The multimode fiber 504 may include at least one curved (or bent) section 511. As a non-limiting example, as illustrated in FIGS. 5A to 5C, the multimode fiber 504 may include three curved (or bent) sections 511. As shown in FIG. 5B, a pitch or period, p, may be defined between adjacent curved sections 511 of the multimode fiber 504.

As shown in FIGS. 5A to 5C, a spacer element 506 may include at least one curved (or bent) section 512, for example, so as to conform to the shape of the multimode fiber 504.

As described above, the sensor arrangement 502, for example, in the form of a sensor mat, may be configured in a manner to include the top and bottom layers 508a, 508b having polyester fibers arranged in a large area mesh-like structure. A section having a multimode fiber 504 and a dummy fiber or plastic rod as a spacer element 506 may be provided in between the top and bottom layers 508a, 508b

The sensing device 500 may further include an optical transceiver 518 optically coupled to the multimode fiber 504. The optical transceiver 518 may include an optical source (e.g., light source) 520 and an optical detector 522. The optical source 520 may be optically coupled to one end of the multimode fiber 504 via an additional optical fiber (e.g., a multimode fiber or a single mode fiber) 523a. The additional optical fiber 523a may in turn be optically coupled to the multimode fiber 504 via a fiber connector 524a or a splicing joint. The optical detector 522 may be optically coupled to another end of the multimode fiber 504 via a further additional optical fiber (e.g., a multimode fiber or a single mode fiber) 523b. The further additional optical fiber 523b may in turn be optically coupled to the multimode fiber 504 via a fiber connector 524b or a splicing joint.

Light from the optical source 520 may be launched into one end of the multimode fiber 504 of the sensor arrangement 502 while another end of the multimode fiber 504 may be connected to the optical detector 522.

In various embodiments, the optical source 520 may be a laser, an LED and/or other broad band or narrow band light sources.

In various embodiments, the optical detector 522 may be used to convert an optical signal to an electronic signal.

The sensing device 500 may further include a processing circuit (e.g., signal processing unit) 526, which may have a display and alarm functions to report, for example, vital signs parameters. Data acquisition and analysis may be done by the processing unit 526 with display and alarm to report vital signs parameters and alert users.

In various embodiments, the sensing device 500 may include a transceiver including or consisting of the light source 520, the detector 522, and the processing unit 526 with display and alarm functions to report and alert users.

In various embodiments, the multimode fiber 504 may be a glass optical fiber, a plastic optical fiber or other types of optical fibers. In various embodiments, each spacer element 506, in the form of a dummy fiber or a dummy tube/rod, may be a glass optical fiber, a plastic optical fiber or other types of rods.

In various embodiments, a protective covering layer (not shown) may be provided or added to the layer 508a and another protective covering layer (not shown) may be provided or added to the layer 508b of the sensor arrangement 502.

In FIG. 5C, the arrow 507 indicates the force or the direction of the force that may be applied to the sensor arrangement 502. For a sensor without a spacer, most of the force is exerted on the multimode fiber. When one or more spacers 506 are used in the sensor arrangement (e.g., sensor mat) 502 of various embodiments, part of the force 507 is transferred to the spacer(s) 506 and the effective force acting on the multimode fiber 504 may be reduced, and thus the dynamical range of the sensor arrangement 502 and of the overall sensing device 500 may be increased.

In various embodiments, a spacer element 506, such as a dummy fiber or a plastic/metal tube/rob, may be placed between two neighboring sections (e.g., 510a, 510b) of the multimode fiber 504. When the force 507 is applied on the sensor arrangement (e.g., sensor mat) 502 as shown in FIG. 5C, the element 506 and the multimode fiber 504 may support the force 507 together or collectively; this may reduce the total force exerted on the multimode fiber 504. As a result, the dynamic working range of the sensor arrangement 502 and the overall sensing device 500 may be increased.

FIG. 6 shows an image 652 of a section of the mesh-like structure of at least one of the top or bottom layers of the sensor mat of various embodiments. As shown in FIG. 6, the top layer and/or the bottom layer may have fibers (e.g., polyester fibers) 654 arranged or coupled to each other in a mesh-like or a grid-like structure. There may be gaps or holes 656 in between sections of fibers 654 or adjacent fibers 654, where each hole 656 may be, for example, a square, a rectangle or any other shape. The pitch, s, of the mesh-like structure may range from a few hundred microns (μm) to a few millimeters (mm). As a non-limiting example, the pitch s may be in between about 100 μm and about 10 mm.

Due to the large area mesh-like structure of the top and bottom layers of the sensor mat, an optical fiber (e.g., a multimode fiber 504) with a longer length may be used to cover a body area positioned on the sensor mat, while the dynamic working range of the sensor mat, and therefore of the overall sensing device, may also be adjusted by using different sizes (e.g., diameters) of dummy fibers or plastic/metal rods/tubes as spacers.

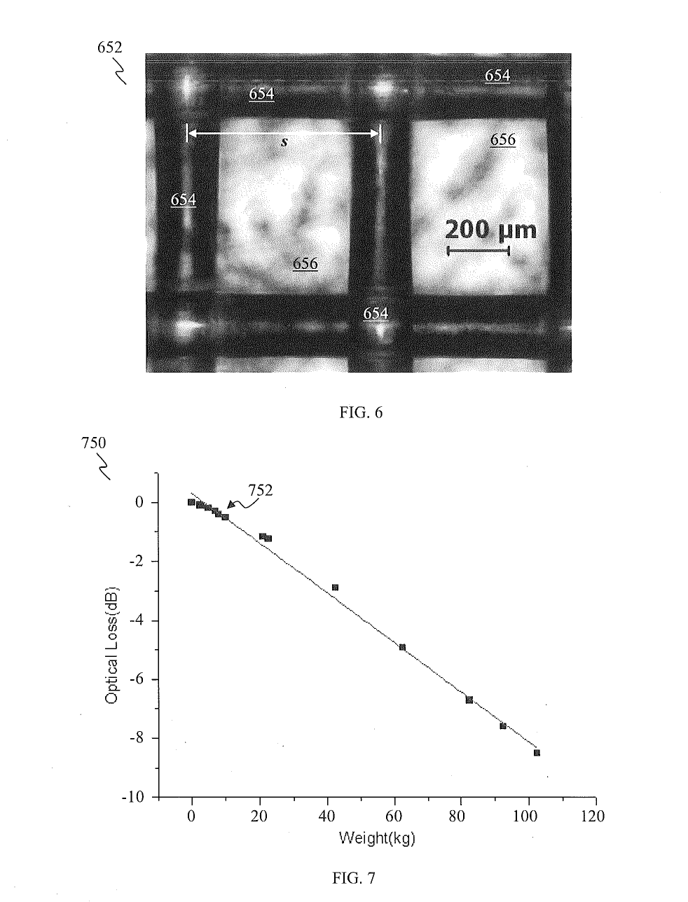

In various embodiments, by choosing or changing at least one of a suitable pitch, s, for the microbends of the optical fiber or multimode fiber, a radius of the optical fiber or multimode fiber (e.g., a radius of the core of the optical fiber or multimode fiber), a numerical aperture (NA) of the optical fiber or multimode fiber, or a diameter of the spacer (or spacer element), the dynamic working range of the sensor mat of various embodiments may be tailored to designed specifications as shown in FIG. 7, where the curve 752 illustrated in plot 750 shows the relationship between the optical loss of the sensing device of various embodiments and the weight applied to the sensor mat of the sensing device.

In various embodiments, the sensor mat 502 as shown in FIG. 5A may be molded together with an elastic material, e.g., a silicon (Si) material, to form a more stable structure, for example, for body force measurement.

In various embodiments, for measurement purposes, the sensor arrangement or sensor mat (e.g., 502) of various embodiments may be placed between a bed sheet and a mattress, or under a mattress. The sensor mat may also be embedded within at least one of a bed sheet, a mattress, a cushion, a pillow, etc. For seating applications, the sensor mat may be placed in the back of the seat or under the seat.

The periodic difference in pressure or force exerted by a human body on the sensor arrangement or sensor mat (e.g., 502) of various embodiments, for example, due to breathing and/or heart beating, may modulate the light propagating along or through or within the optical fiber or multimode fiber (e.g., 504). For example, when the the back of the body of the user of the sensor mat tosses or moves on the sensor mat, the light propagating within the multimode fiber may be modulated according to the user's movement. The light may be modulated in terms of its amplitude and frequency. The information of at least one of breathing rate, heart beat rate, body force or body movement of the user may be obtained by extracting and processing of the modulated light by a signal processing unit (e.g., 526).

For adipose patient applications, the body weight is usually larger than about 100 kg. In such applications, a sensor mat without a spacer would not work because the sensor mat works in a very low sensitive range, as described above, or there may even be no light output. However, in various embodiments of the sensor arrangement or sensor mat where a spacer or spacer element is used, the sensor mat may be operated in a reasonably sensitive range so that the sensing device or sensing system may work normally for various applications, including for adipose patient applications.

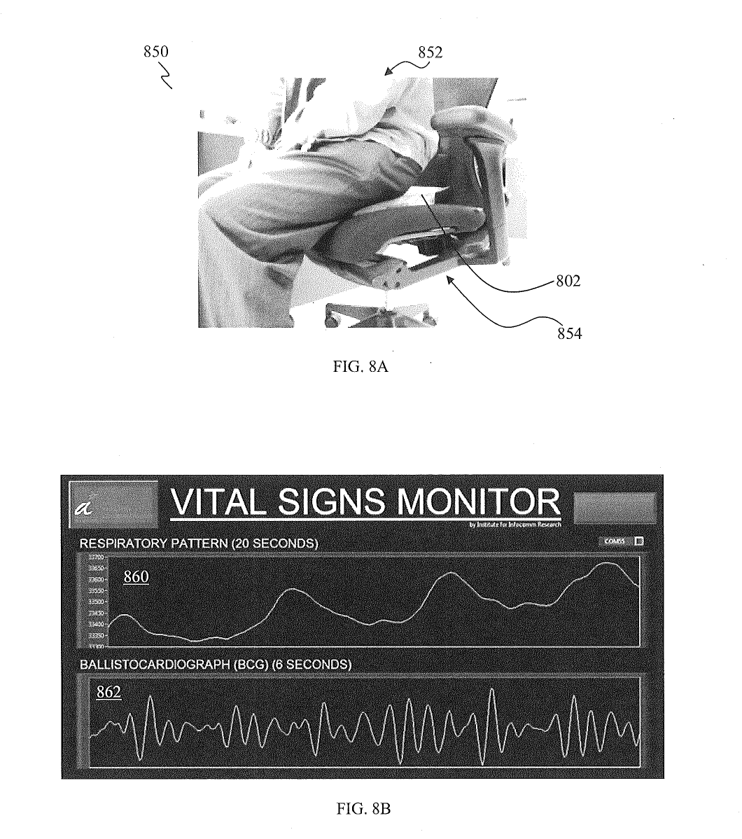

FIGS. 8A and 8B show measurement results for seating applications using the sensor mat of various embodiments. FIG. 8A shows an image 850 of a person (user) 852 sitting on a sensor arrangement or sensor mat 802 with spacer(s) on a chair 854. FIG. 8B shows a typical breathing pattern (respiratory pattern) 860 and a typical heart beating pattern (ballistocardiogram (BCG) signal/waveform) 862, measured using the sensor mat 802 with spacer(s). It may be observed that the person's breathing and heart beat signals may be measured correctly.

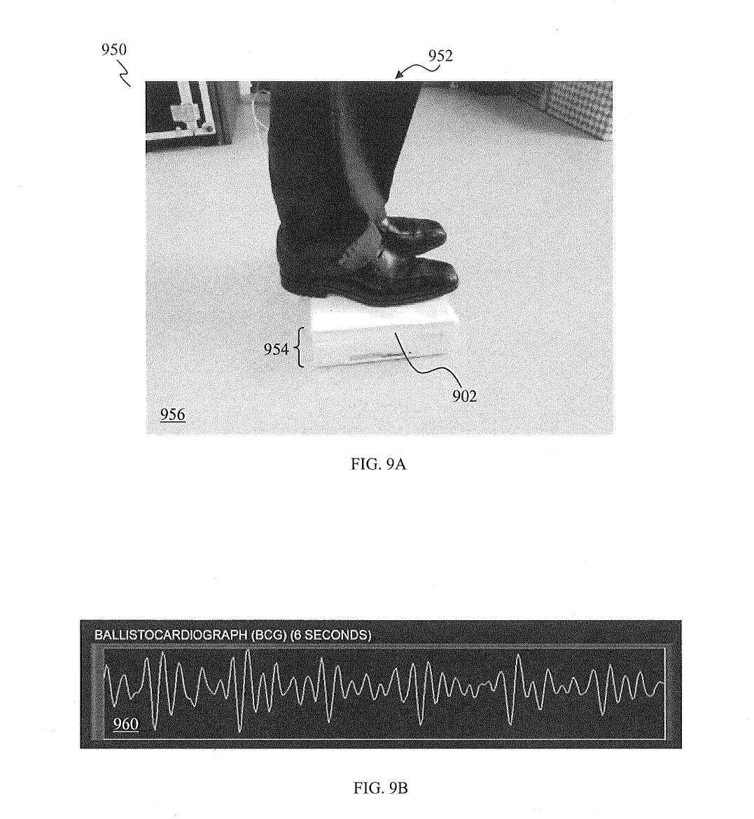

In order to demonstrate the capacity and capability of the sensor arrangement or sensor mat of various embodiments for large dynamic working range, a user 952 with a body weight of about 55 kg, as shown in the image 950 of FIG. 9A, may stand on a sensor mat 902 with spacer(s), placed in a stack of paper 954, on the floor 956. FIG. 9B shows the measurement results for standing applications using the sensor mat of various embodiments, illustrating a ballistocardiogram (BCG) signal/waveform 960 measured using the sensor mat 902 with spacer(s). As may be observed, the ballistocardiogram (BCG) signal 960 may still be measured. The heart beating of the user 952 may be clearly seen in the BCG signal 960. The breathing rate may be derived based on the breathing induced modulation on the BCG signal 960.

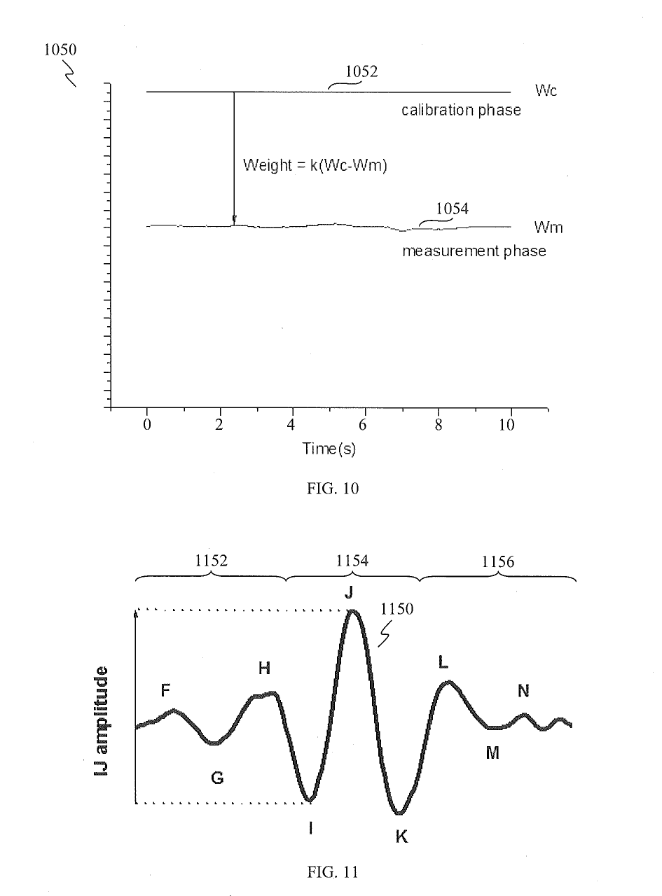

In various embodiments, for body weight measurement, the following non-limiting method may be used to calculate the body weight as shown in FIG. 10.

FIG. 10 shows a diagram 1050 illustrating a method used for body weight measurement, according to various embodiments. The method may include the following:

(1) Calibration phase: In this phase, body weight is not applied to the sensor arrangement or sensor mat. Data is acquired in a preset or predetermined period, e.g., 10 s. The mean of the curve, Wc (as represented by 1052), is calculated.

(2) Measurement phase: In this phase, body weight is applied to the sensor arrangement or sensor mat. Data is acquired in a preset or predetermined period, e.g., 10 s. The mean of the curve, Wm (as represented by 1054), is calculated.

(3) Report result: In this phase, the relative body weight change, RW, may be determined using the relationship of

RW=k(Wc−Wm) (Equation 1),

where k is a calibration coefficient.

It should be appreciated that for the measurement described above, the subject or user may be, for example, in a lying position or a standing position.

Similar to body weight measurement, cardiac force may also be measured. FIG. 11 shows a typical ballistocardiogram (BCG) waveform 1150 measured from a subject (user) using the sensor arrangement or sensor mat of various embodiments. The measured BCG waveform 1150 may be divided into three phases:

(1) pre-ejection (FGH), as represented by 1152;

(2) ejection (IJK), as represented by 1154; and

(3) diastolic portion of the heart cycle (LMN), as represented by 1156.

The key parameters, such as the GH, HI, IJ and JK amplitudes may be used to calculate the cardiac forces. For example, once the IJ amplitude or the arithmetic mean of the HI, IJ and JK amplitude is known, the cardiac force, CF, may be obtained according to

CFij=k*(IJ amplitude) (Equation 2)

or

CFhiijjk=k*(mean of the HI, IJ and JK amplitude) (Equation 3),

where k is a calibration coefficient.

Measurement may be carried out from a subject using the above-mentioned method and sensing device of various embodiments. In a non-limiting example, the mean of the IJ and JK amplitude is determined to be about 24.5 amplitude unit and the calibrated k is about 0.00733 kg/amplitude unit. Therefore, the cardiac force may be determined as

CFijjk=0.00733*24.5=0.18 kg.

As described above, various embodiments may provide a method and a device to adjust a microbending fiber sensor mat's dynamic working range by using a dummy fiber or a plastic/metal tube/rod as a spacer. The spacer may be located with the section of the sensing multimode fiber of the sensor mat, in between top and bottom layers containing polyester fibers with large area mesh-like structures.

Various embodiments may provide a method and a device to measure at least one of breathing rate, heart rate, body weight and body force, e.g., cardiac force from a ballistocardiogram (BCG) waveform in a lying, or seating or standing position by using the microbend fiber sensor mat of various embodiments.

As described above, the sensing device of various embodiments may be capable of working with a large dynamic working range. The sensing device may find applications for adipose patients and for security applications, for example, to measure people's breathing rate, heart rate variability and body weight where the person may not even know that he is under monitoring to know whether the person is lying or hiding something during security check. The sensor arrangement or sensor mat of various embodiments may also be used for monitoring vital signs at hospitals and at home. Another application is that the sensing device and method may be used for non-invasive assessment of heart force/pressure.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A sensing device comprising:
a sensor arrangement comprising:
an optical fiber; and
at least one spacer element arranged adjacent to the optical fiber;
wherein the optical fiber and the at least one spacer element are adapted to cooperate to receive a force applied to the sensor arrangement to modulate an optical signal propagating in the optical fiber.

2. The sensing device as claimed in claim 1, wherein the optical fiber and the at least one spacer element are arranged spaced apart from each other.

3. The sensing device as claimed in claim 1, wherein the optical fiber and the at least one spacer element are arranged in a same plane.

4. The sensing device as claimed in claim 1, wherein the optical fiber is arranged in a serpentine shape, and having at least two sections facing each other.

5. The sensing device as claimed in claim 4, wherein the at least two sections of the optical fiber are arranged at least substantially parallel to each other.

6. The sensing device as claimed in claim 4, wherein the at least two sections of the optical fiber are arranged spaced apart from each other.

7. The sensing device as claimed in claim 4, wherein the at least one spacer element is arranged in between the at least two sections of the optical fiber.

8. The sensing device as claimed in claim 1, wherein the optical fiber is arranged with at least one curved section.

9. The sensing device as claimed in claim 1, wherein the optical fiber comprises a multimode optical fiber.

10. The sensing device as claimed in claim 1, wherein the at least one spacer element comprises at least one of a dummy optical fiber, a tube or a rod.

11. The sensing device as claimed in claim 1, wherein the sensor arrangement further comprises a pair of cover layers, and wherein the optical fiber and the at least one spacer element are arranged in between the pair of cover layers.

12. The sensing device as claimed in claim 11, wherein each cover layer of the pair of cover layers comprises a plurality of fibrous materials arranged in a mesh-like structure.

13. The sensing device as claimed in claim 12, wherein the plurality of fibrous materials comprise at least one of a polymer, a metal or a plastic material.

14. The sensing device as claimed in claim 12, wherein a gap is defined between adjacent fibrous materials of the plurality of fibrous materials arranged in the mesh-like structure.

15. The sensing device as claimed in claim 1, further comprising an optical transceiver optically coupled to the optical fiber of the sensor arrangement.

16. The sensing device as claimed in claim 15, wherein the optical transceiver comprises an optical source configured to generate the optical signal propagating in the optical fiber.

17. The sensing device as claimed in claim 15, wherein the optical transceiver comprises an optical detector configured to detect the optical signal that is modulated by the force applied to the sensor arrangement.

18. The sensing device as claimed in claim 1, further comprising a processing circuit configured to retrieve information corresponding to the force from the optical signal that is modulated by the force applied to the sensor arrangement.

19. A method for sensing a force, the method comprising:
providing an optical signal to an optical fiber for propagation in the optical fiber;
applying a force to the optical fiber and at least one spacer element arranged adjacent to the optical fiber to modulate the optical signal propagating in the optical fiber; and
detecting the optical signal modulated by the force.

20. The method as claimed in claim 19, further comprising retrieving information corresponding to the force from the detected optical signal.
